(19) United States
(12) Patent Application Publication
(10) Pub. No.: US 2012/0258327 A1
(43) Pub. Date: Oct. 11, 2012

(54) LIGNOCELLULOSIC MATERIAL AND MODIFICATION OF LIGNOCELLULOSIC MATERIAL

(75) Inventors: Peter McArthur, London (GB); Justin Martin, Ramsey (IM); Roy Tilleard, Colby (IM)

(73) Assignee: KURAWOOD PLC, London (GB)

(21) Appl. No.: 13/222,903

(22) Filed: Aug. 31, 2011

Related U.S. Application Data
(63) Continuation of application No. PCT/GB09/51411, filed on Oct. 20, 2009.

(30) Foreign Application Priority Data
Oct. 23, 2008 (GB) 0819436.7

(51) Int. Cl. B27K 3/15; B32B 21/04; B05D 7/06

(52) U.S. Cl. 428/541; 427/384; 427/385.5; 427/297

(57) ABSTRACT

There is herein described a method for treating lignocellulosic material and lignocellulosic material formed from such a method. More particularly, there is described a method for treating lignocellulosic material which introduces organic material into the lignocellulosic material and which produces a modified lignocellulosic material which has increased strength and is highly durable.

### CROSS-REFERENCE TO RELATED APPLICATIONS

This application is a continuation of International Application PCT/GB09/51411, with an international filing date of Oct. 20, 2009, now abandoned, which in turn claims priority of United Kingdom Patent Application No. 0819436.7, filed Oct. 23, 2008. The disclosures of all such applications are hereby incorporated herein by reference in their respective entireties, for all purposes.

### FIELD OF THE INVENTION

The present invention relates to a method for the chemical modification of lignocellulosic material and lignocellulosic material formed from such a method. More particularly, the present invention relates to a method for modifying lignocellulosic material which introduces organic material in the lignocellulosic material.

### BACKGROUND OF THE INVENTION

Although there are many prior art methods for treating lignocellulosic material which increase the strength and longevity of lignocellulosic material, these prior art methods involve the addition of materials into the lignocellulosic material which results in a modified lignocellulosic material which contains effective toxins such as biocides or other inorganic materials capable of destroying microorganisms which attack and render the entire product environmentally unattractive. Other lignocellulosic material modification processes involve the use of inorganic solvents, dangerous inorganic chemicals, strippers, or materials which are polymerised using radiation otherwise considered to be harmful to humans.

There is therefore a need in the art for a method of treating lignocellulosic material which does not contain toxic, hazardous and/or environmentally unfriendly materials and that can be produced with low energy inputs and with low risk to humans and which provides longevity and/or strength to lignocellulosic material.

It is an object of at least one aspect of the present invention to obviate or mitigate at least one or more of the aforementioned problems.

It is a further object of at least one aspect of the present invention to provide a method for treating lignocellulosic material which provides additional strength and/or longevity to the lignocellulosic material and wherein the treatment uses organic based materials.

### SUMMARY OF THE INVENTION

According to a first aspect of the present invention there is provided a method for providing a hardened lignocellulosic material product said method comprising: providing a lignocellulosic material product; impregnating the lignocellulosic material product with an aqueous organic based formulation; providing a pressurised environment for the lignocellulosic material product impregnated with the aqueous organic based formulation; heating the lignocellulosic material product with the Impregnated organic based formulation to thereby cure organic material within the lignocellulosic material product; wherein the cured organic material within the lignocellulosic material product increases the strength of the lignocellulosic material product and provides a hardened lignocellulosic material product.

The present invention therefore relates to a method for treating lignocellulosic material (e.g. wood) which improves, for example, the hardness and/or strength of the lignocellulosic material. The treated lignocellulosic material may substantially retain the look and feel of natural timber, it is also found that volume and/or density may also be added to the lignocellulosic material as the aqueous organic based formulation may impregnate itself within and/or onto the microstructure of the lignocellulosic material. The treated lignocellulosic material may be found to have greater longevity than untreated lignocellulosic material and may resist shrinkage and/or warping. The treated lignocellulosic material may therefore have improved hardness, dimensional stability, durability, machinability and/or coat ability.

The lignocellulosic material may be any type of wood based material wherein the cured organic material may be crosslinked within the lignocellulosic material product.

A further advantage of the present invention is that the lignocellulosic material pre- and post-modification may retain substantial the same dimensions. This is an advantage as prior art treatments result in shrinkage of the lignocellulosic material which may lead to inconsistencies and/or weak areas being formed in the treated lignocellulosic material.

The present invention also provides for the advantageous feature that the organic material trapped within the lignocellulosic material product does not adversely affect the lignocellulosic material such as causing rot as would be done by a sugar based material (e.g. maltodextrin) if that were left in the lignocellulosic material. The cured organic material is also not edible by wood-destroying material such as fungi and insects. The present invention may therefore not use sugars, for example, maltodextrin or oligosaccharides. Furthermore, the present invention may not use an external catalyst such as from the group consisting of ammonium salts, metal sails, organic acids, inorganic acids and mixtures thereof. The present invention may also not use a setting agent (e.g. 2,2-bis{t-butyl peroxy)butane, 2,5-dimethyl-2,5-di(t-butyl peroxy)hexane, 2,5-dim8thyl-2,5-di(t-butyl peroxy)hexyne-3, n-butyl-4,4-bis(t-butyl peroxy)valerate, 1,1-bis(t-butyl peroxy)-3,3,5-trimethyl cyclohexane, and mixtures thereof) which again reduces complexity and cost in the manufacture of the formulation.

A further advantage of the present invention may also be that the lignocellulosic material preferably does not need a pre-treatment or preparation step such as with an acidic material (e.g. sulphur dioxide which may act as a catalyst). The present invention may therefore rely on the natural acidity of the lignocellulosic material. The present invention may therefore be a one-step procedure and not a two-step procedure such as found in prior art techniques.

The present invention also preferably uses water as a solvent for the aqueous organic based formulation and preferably does not use toxic and/or volatile solvents. The solvent may be in an ionic or a non-ionic form. Many prior art methods use toxic materials (e.g. styrenes and polyesters) or gamma radiation which leads to a complex and dangerous treatment procedure. Using a water based system also makes the system much more cost effective and efficient to use industrially. Other prior art methods also use an argon or nitrogen gas based atmosphere system which again leads to a costly complicated process. The present invention preferably does not use an inert gas atmosphere such as argon and avoids using toxic materials (e.g. styrenes and polyesters). The present invention therefore preferably uses standard atmospheric air.

The aqueous organic based formulation may react with the lignocellulosic material to produce a biopolymer within said lignocellulosic material. The resulting product retains the visual appearance of the lignocellulosic material but however contains a significant quantity of the new biopolymer which has a beneficial effect on a number of characteristics of the lignocellulosic material, These improved features are noted as any one of or combination of the following: Increased density; increased hardness; increased strength; increased stiffness; increased fire resistant properties; and improved performance when machined, coated with surface coating materials including surface stains, lacquers, paints and powder coatings of all types.

The lignocellulosic material product may be a soft lignocellulosic material such as lignocellulosic material selected from any one of or combination of the following: Pines; Hemlocks; Aspen; Beach; Birch; Albizzia; Balsa; Iroko (chlorophora excelsa); Jelutong (dyera costulata); Merbau (intsia palembacia); Tawa (beilschmiedia tawa); Radiata Pine (pinus radiate); European Beech (gagus sylvatica); Eucalyptus (eucalyptus deglupta); Cotton Wood (populus deltoids); Rubber Wood (hevea brassilensis); Baltic Pine (pinus sylvestris); Ponderosa Pine (pinus ponderosa); Hoop Pine (araucaria cunninghamii); Carribbean Pine (pinus caribaea); Loblolly Pine (pinus taeda); Hemlock (tsuga canadensis); Western Juniper (juniperus occidentalis); Poplar (liriodendron tulipifera); Willow (salix nigra); Slash Pine (pinus elliottii); White Pine (pinus strobes); Poplar Hybrid (popuius dehoidesXnigra) or Corsican Pine (pinus nigra subsp. laricio).

The term lignocellulosic material product is also intended to cover timber or lumber, which is either standing or which has been processed for use. In the

UK and Australia, “timber” is a term also used for sawn lignocellulosic material products (that is, planks or boards), whereas generally in the United States and Canada, the product of timber cut into planks or boards is referred to as “lumber”.

The lignocellulosic material for the present invention may be lignocellulosic material obtained directly from cutting from a felled tree. The member of lignocellulosic material may be of any dimension but may preferably be constituted of entirely lignocellulosic material from the felled tree, being the newly formed outer lignocellulosic material located just inside the vascular cambium of a tree trunk and active in the conduction of water.

The hardened lignocellulosic material product may be used in a variety of uses where timber products are used externally such as soffets, window frames, cills, doors and door frames, conservatories, barge boards, fascia boards, garden sheds, decking and timber framed buildings and the like. Alternatively, the hardened lignocellulosic material product may be used for indoor products as well such as furniture, for joinery products and for food items such as food bowls.

The member of lignocellulosic material used in the present invention may be a soft lignocellulosic material but after treatment according to the present invention the member of lignocellulosic material may have many of the properties of a hard lignocellulosic material. As is well known, the use of hard lignocellulosic materials is restricted due to their expense and time to grow such trees. The present invention therefore also provides significant conservation benefits as it reduces the use of hard lignocellulosic materials. In fact any type of lignocellulosic material product may be used so long as it is capable of absorbing the aqueous organic based formulation. Preferably, about 1 m³ of the lignocellulosic material product may absorb greater than about 100 litres, 200 litres, 300 litres, 400 litres, 500 litres, 800 litres, 700 litres, 800 litres, 900 litres or 1,000 litres of the aqueous organic based formulation, Preferably, about 1 m³ of the lignocellulosic material product may absorb greater than about 500 litres of the aqueous organic based formulation. By being absorbed is also meant to cover impregnation,

The aqueous organic based formulation may be absorbed and/or impregnated into the lignocellulosic material product such as into and/or onto the microstructure of the lignocellulosic material containing the cells, cell walls and/or pores.

The pressurised environment may be a pressure vessel within which the lignocellulosic material product may be placed and sealed. The pressurised environment may be used to reduce and/or increase the air pressure around the lignocellulosic material product

Initially, the lignocellulosic material product may be placed in the pressure vessel. In a first step, the pressure inside the pressure vessel may be reduced below atmospheric pressure and preferably down to a vacuum or substantially a vacuum. Typical pressures may, for example, be below about 100 kPaₛ below about 80 kPa, below about 80 kPa, below about 40 kPa, below about 20 kPa or below about 10 kPa. Any suitable type of pump such as a vacuum pump may be used for such a process.

Typically, a vacuum of, for example about −20 to −200 kPa or typically about −80 kPa, may be drawn from the pressure vessel for a period of time such as, for example, about 10 minutes to 2 hours or typically about 30 minutes. By reducing the pressure has the effect that cells and/or pores in the microstructure within the lignocellulosic material product may be evacuated of air.

The reduction in pressure may be stopped or continued (i.e. the vacuum pump may be left running), The aqueous organic based formulation may then be introduced into the reduced pressure environment such as the pressure vessel. The organic based formulation may be introduced at a slow rate or preferably may be flooded as quickly as possible. The aqueous organic based formulation may be fed into the reduced pressure environment until the environment is full or substantially full with the organic based formulation. The reduced pressure such as the vacuum may therefore be used to draw the organic based solution into the reduced pressure environment. Although it is not essential to initially reduce the pressure, this simply facilitates the feeding of the aqueous organic based formulation Into the pressure vessel due to the negative pressure, it has also been found that such a process is also highly advantageous as this allows good impregnation of the aqueous organic based formulation into the microstructure of the lignocellulosic material product. This has been found to be much more efficient than simply soaking the lignocellulosic material product in the aqueous organic based formulation.

Once the aqueous organic based solution is in the pressure vessel and has been absorbed and/or impregnated into the lignocellulosic material structure, the pressure in the pressure vessel may then be increased to above, for example, atmospheric pressure and for example, above 2 or 3 atmospheric pressures. For example, the pressure pump may be used to increase the pressure. Pressures above about 200 kPa, above about 500 RPa₁ above about 1,000 kPa or above about 1,500 kPa may be used. Typically, a pressure of about 1,400 kPa may be used. The pressure vessel with the fluid of the aqueous organic based formulation therein may then be kept at this increased pressure for a period of time such as at least about 5 minutes, at least about 10 minutes, at least about 20 minutes, at least about 30 minutes, at least about 40 minutes, at least about 50 minutes or at least about 80 minutes. Maintaining the high pressure increases the absorption and/or impregnation of the aqueous organic based formulation into the microstructure of the lignocellulosic material product.

Once the aqueous organic based formulation has been absorbed and/or impregnated into the microstructure of the lignocellulosic material product such as the pores, cells and/or cavities, the increased pressure in the pressure vessel may be released and any excess aqueous organic based formulation may be drained and/or removed.

The method of the present invention may then include a further step of once again reducing the pressure inside the pressure vessel again using a vacuum pump pumping at, for example, about −80 kPa. The pressure may be reduced down to a vacuum or substantially a vacuum. The pressure may be maintained at the reduced pressure for a period of time such as at least about 5 minutes, at least about 10 minutes, at least about 20 minutes, at least about 30 minutes, at least about 40 minutes, at least about 50 minutes or at least about 60 minutes. This further reduction of pressure may be used to remove any surplus organic based formulation from the surface of the lignocellulosic material product and may also facilitate the impregnation and/or absorption of the aqueous organic based formulation into the microstructure of the lignocellulosic material product.

The pressure may then be allowed to return to normal atmospheric pressure. This return to normal atmospheric pressure may be allowed to occur quickly by opening a relief valve quickly. This sudden change of pressure may also facilitate the impregnation and/or absorption of the aqueous organic based formulation into the microstructure of the lignocellulosic material product.

Typically, any one of or combination of the above steps relating to the impregnation of the aqueous organic based formulation may be performed at room temperature, Preferably, all of the above steps relating to the impregnation of the aqueous organic based formulation may be performed at room temperature. This is a significant improvement over prior art techniques which usually use high elevated temperatures. The present invention therefore does not use above room temperature or elevated temperatures during the Impregnation of the aqueous organic based formulation. This has significant cost benefits as this provides lower energy consumption and allows less complex apparatus to be used.

The lignocellulosic material product may then be removed from the pressure vessel and a heat treatment applied. Any suitable type of heat treatment may be used such as an oven, hot air drying or treatment with a laser. In particular embodiments a kiln may be used. The lignocellulosic material product may be heated to about 50° C.-200° C. or about 80° C.-80° C. with an airflow of, for example, about 8 m/s. By heating the lignocellulosic material product with the impregnated organic based formulation may cure the aqueous organic based formulation within the lignocellulosic material product. Organic material may therefore be cured and/or set and/or fused within and/or onto the microstructure of the lignocellulosic material product. The cured organic material within the lignocellulosic material product may increase the strength of the lignocellulosic material product and provides a hardened lignocellulosic material product. The amount of organic material that can be deposited into the microstructure of the lignocellulosic material may be varied by increasing the solids content of the organic aqueous formulation.

Typically, the organic aqueous, formulation may have a solids content of about 10% by weight (67 kg/m³}, about 20% by weight (134 kg/m³}, about 30% by weight (201 kg/m³), about 40% by weight (268 kg/m³), about 50% by weight (335 kg/m³) or about 80% by weight (402 kg/m³),

As used herein “cure” (and related words such as “curing”) includes polymerisation, etc. or other chemical reformation, irrespective of whether or not to completion, Typically, the aqueous organic based formulation may be a solution comprising an organic material of high molecular weight polymer or resin with a molecular weight of between any of the following: 100-10,000; 150-5,000: 200-1,000; 250-750; 250-500; or 290-470. The aqueous organic based formulation may substantially use water as the solvent although any other suitable solvents may also be used. The molecular weight of the organic material in the aqueous organic based formulation relates to the rate and ability for the organic material to penetrate into the lignocellulosic material and also stay there once the pressure has been returned to atmospheric pressure. For example, the organic material may be a high molecular weight polymeric based material such as a condensation polymer or an amide, an amine, an ester, aldehyde, ketone, anhydride or an alkyd based material. For example, the alkyd based material may be an alkyd resin. An alkyd resin may be a synthetic resin formed by the condensation of polyhydric alcohols with polybasic acids. The most common polyhydric alcohol used may be glycerol, and polybasic acid may be phthalic anhydride. Modified alkyds may be those in which the polybasic acid may be substituted in part by a monobasic acid, of which the vegetable oil fatty acids are typical. !n particular embodiments, the aqueous organic based formulation and/or organic material may be based on a coconut alkyd such as high-solids, short oil alkyds with a viscosity measure of, for example, Z₅ to Z₆ on the Gardner-Holdt Viscometer Scale a! 30° C. Typically, the molecular weight of the aqueous organic based formulation may be sufficiently low to enable the organic based solution to pass through the lignocellulosic material surface, ceil walls and/or pores of the lignocellulosic material product. As indicated above this process may be achieved (i.e. catalysed) through pressure and/or heat. The aqueous organic based formulation may comprise a solvent used in which may be driven and/or evaporated off leaving behind an organic material that binds and cures to the microstructure of the lignocellulosic material product (e.g. inside the lignocellulosic material product) such as the cell wails and/or pores. The organic material remains within the microstructure once it is forced into the microstructure under increased pressure. This is facilitated by the relatively high molecular weights of the organic material. The increased pressure and/or heat helps to start a chemical reaction of the aqueous organic based formulation and starts a curing process,

Using the process of the present invention, the hardened lignocellulosic material product formed may have a Janka hardness of: at least about 5,000 N/mm²: at least about 8,000 N/mm²; at least about 7,000 N/mm²; at least about 8,000 N/mm²; at least about 8,000 N/mm²; at least about 9,000 N/mm² or at least about 10,000 N/mm². Typically, the hardened lignocellulosic material product formed may have a Janka hardness of; about 4,000 N/mm²-20,000 N/mrn²; about 4,000 N/mm²-15,000 N/mm²; about 4,000 N/mm²-12,QGG N/mm² or about 7,000 N/mm²-10,000 N/mm². Using the present invention the hardness of the initial lignocellulosic material product may be increased by at least about 10%, at least about 30%, at least about 50%, at least about 70%, n\ least about 100% or at least about 200%, (The Janka Hardness is based on lignocellulosic material conditioned at 65% relative humidity and 200° C., Values are heavily influenced by local growth conditions, Using the process of the present invention, the hardened lignocellulosic material product formed may have a density of: at least about 500 kg/m³; at least about 600 kg/m³: at least about 700 kg/m³; at least about 800 kg/m³; at least about 900 kg/m³ or at least about 1,000 kg/m³. Typically, the hardened lignocellulosic material product formed may have a density of: about 400-2,000 kg/m³; about 400-1,500 kg/m³; about 500-1,000 kg/m³; about 800-2,000 kg/m³; about 700-2,000 kg/m³. Using the present invention the density of the initial lignocellulosic material product may be increased by at least about 10%, at least about 30%, at least about 50%, at least about 70%, at least about 100% or at least about 200%,

According to a second aspect of the present invention there is provided a hardened lignocellulosic material product which has organic material cured within the lignocellulosic material product which increases the strength of the lignocellulosic material product and provides a hardened lignocellulosic material product.

The hardened lignocellulosic material product may be formed using the method as described in the first aspect,

According to a third aspect of the present invention there is provided use of the hardened lignocellulosic material product as defined in the first aspect in soffets, window frames, window sills, doors and door frames, conservatories, barge boards, fascia boards, garden sheds, decking and timber framed buildings and the like and indoor products as well such as furniture, for joinery products and for food items such as food bowls.

### BRIEF DESCRIPTION OF THE DRAWINGS

Embodiments of the present invention will now be described, by way of example only, with reference to the accompanying drawings in which:

FIG. 1 is a representation of dimensional stability for a lignocellulosic material product according to an embodiment of the present invention (Vecowood) and a comparison with other untreated lignocellulosic material products.

### BRIEF DESCRIPTION

Generally speaking, the present invention resides in the provision of introducing organic material into a lignocellulosic material product and curing the organic material within the microstructure of the lignocellulosic material product, This produces a modified lignocellulosic material which has increased strength and is highly durable,

Initially the lignocellulosic material product may be a soft lignocellulosic material product (e.g. Pines; Hemlocks; Aspen; Beach; Birch Wood; Albizzia; Balsa; Iroko (chlorophora excelsa); Jelutong (dyera costulata); Merbau (intsia palembacia); Tawa (beilschmiedia tawa); Radiata Pine (pinus radiate); European Beech (gagus sylvatica); Eucalyptus (eucalyptus deglupta); Cotton Wood (populus deltoids); Rubber Wood (hevea brasiliensis); Baltic Pine (pinus sylvestris); Ponderosa Pine (pinus ponderosa); Hoop Pine (araucaria cunninghamii); Carribbean Pine (pinus caribaea); Loblolly Pine (pinus taeda); Hemlock (tsuga canadensis); Western Juniper (juniperus occidentals); Poplar (liriodendron tulipifera); Willow (salix nigra); Slash Pine (pinus elliottii); White Pine (pinus strobes); Poplar Hybrid (populus dehoidesXnigra) or Corsican Pine (pinus nigra subsp. laricio)) which is placed in a pressure vessel which is then sealed. The pressure within the pressure vessel is then reduced using a vacuum pump operating at about −80 kPa for about 30 minutes. The pressure is reduced down to a vacuum or substantially a vacuum. A vacuum pump is used for this process.

As pumping is continued an aqueous organic based formulation is then quickly flooded into the pressure vessel. The reduced pressure, in effect, sucks the aqueous organic based formulation into the pressure vessel and into the lignocellulosic material product. The lignocellulosic material product therefore starts to become impregnated and/or absorbed with the aqueous organic based formulation. The aqueous organic based formulation is therefore absorbed and/or impregnated into the lignocellulosic material product such as into the microstructure of the lignocellulosic material containing the cells, cell walls and/or pores. About 1 m³ of the lignocellulosic material product is capable of absorbing about 670 litres of the aqueous organic based formulation.

Once the aqueous organic based formulation has been absorbed and/or impregnated into the lignocellulosic material structure, the pressure in the pressure vessel is then increased to above, for example, atmospheric pressure. For example, the pressure pump is used to increase the pressure to about 1,400 kPa. Maintaining the high pressure increases the absorption and/or impregnation of the aqueous organic based solution into the microstructure of the lignocellulosic material product.

Once the aqueous organic based formulation has been absorbed and/or impregnated into the microstructure of the lignocellulosic material product such as the pores, cells and/or cavities* the increased pressure in the pressure vessel is released and any excess aqueous organic based formulation Is drained and/or removed.

The pressure inside the pressure vessel is then reduced again using a vacuum pump pumping at, for example, about −80 kPa, The pressure may be reduced down to a vacuum or substantially a vacuum,

The pressure is then allowed to return to normal atmospheric pressure. This return to normal atmospheric pressure is allowed to occur quickly by opening a relief valve quickly,

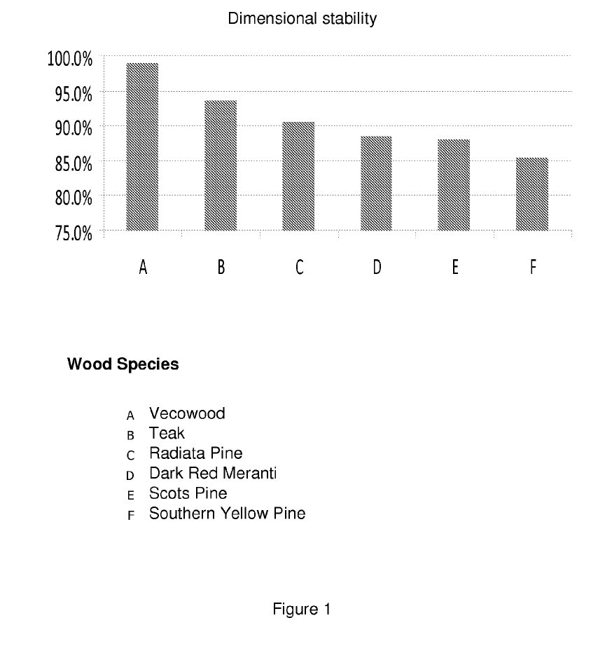

A heat treatment is then applied to the lignocellulosic material product with the aqueous organic material impregnated into the microstructure of the lignocellulosic material product. A kiln is used for the heat treatment. The lignocellulosic material product is heated to about 60° C.-80° C. with an airflow of, for example, about 8 m/s. By heating the lignocellulosic material product with the impregnated organic based formulation cures the aqueous organic based formulation within the lignocellulosic material product. Organic material is therefore cured within the microstructure of the lignocellulosic material product. The cured organic material within the lignocellulosic material product increases the strength of the lignocellulosic material product and provides a hardened lignocellulosic material product. FIG. 1 represents a hardened lignocellulosic material product of the present invention referred to as Vecowood. On the y-axis is dimensional stability (i.e. resistance to swelling and shrinkage) both in radial and tangential directions. FIG. 1 therefore clearly shows that the Vecowood product which has been treated according to the present invention has greater dimensional stability than untreated teak, Radiata a Pine, Dark Red Meranti, Scots Pine and Southern Yellow Pine. The aqueous organic based formulation contains an alkyd resin,

Tests have shown a reduction In swelling caused by moisture uptake of about 90% plus, depending upon the source species and conditions. The swelling and shrinkage of the Vecowood product is only minima! and, in fact, is better than the best tropical timbers available. Table 1 below details the tangential shrinkage, radial shrinkage, volume shrinkage and dimensional stability for the Vecowood product and the untreated teak, Radiata Pine, Dark Red Meranti, Scots Pine and Southern Yellow Pine.

TABLE 1

| Lignocellulosic | Tangential | Radial | Volume | Dimensional |
|---|---|---|---|---|
| material Species | Shrinkage | Shrinkage | Shrinkage | Stability |
| A—Vecowood | 0.6% | 0.4% | 1.0% | 99.0% |
| B—Teak | 4.2% | 2.2% | 6.5% | 93.5% |
| C—Radiata Pine | 6.0% | 3.3% | 9.5% | 90.5% |
| D—Dark Red Meranti | 7.3% | 3.8% | 11.4% | 88.6% |
| E—Scots Pine | 7.7% | 4.0% | 12.0% | 88.0% |
| F—Southern Yellow | 8.0% | 6.1% | 14.6% | 85.4% |
| Pine | | | | |

The production method of the present invention therefore does not weaken the original lignocellulosic, material species—in fact, its density and hardness are significantly improved to produce an exceptionally strong lignocellulosic material. Indeed, no modification process exists which offers the performance benefits and retained physical properties of the present invention.

### EXAMPLES

### Example 1

A suitable formulation for the aqueous organic based formulation is as below: a, Water—clean fresh water from industrial supply b. Urea—granulated fertilizer grade free of impurities c. Glyoxa—40% in water d. Formalin—37% solution of formaldehyde in water e. Alkyd resin—high-solids, short oil alkyds with a viscosity of Z₅-Z₆ (G-H at 30° C.) or better Melamine—industrial powder >98% purity f. Acid dyes—industrial grade

A suitable manufacture of 1000 kg (i.e. total weight) formulation with a solids content of 22% is as below:

Water—600 L

Formalin—198 L

Glyoxal—94 L

Melamine—4.7 kg

Urea (1)—83,0 kg Urea (2)—15.8 kg

Alkyd resin—2,5 kg

Procedure:

a. Place water in corrosion resistant mixing vessel

b. Add Formalin

c. Add Glyoxal

d. Add Melamine, stir vigorously until batch goes clear

e. Add urea (1), stir until batch goes clear

f. Increase pH to 9.00 using sodium hydroxide

g. Hold pH at 9.0 for 6 hours, using occasional stirring

h. Lower pH to 8.0 using HCl

i. Hold pH at 8.0 for 30 minutes

j. Add urea (2) and stir until dissolved

k. Adjust pH to 7.2

l. Monitor pH dally and maintain pH at 7.2 m. Add alkyd resin slowly while stirring prior to use

### Example 2

New Zealand Pinus Radiata with a moisture content of less than 15% will accept an average impregnation of 670 kg/m³ using the Bethel Cell process. Weight gain following the process can be calculated using the following formula:

Average initial mass of Pinus Radiata 450 kg/ra³ at 8% moisture content

Solids content of formulation 22%

Average volume of formulation 870 kg/m³ pumped Into Pinus Radiata

Solids in pumped into Pinus Radiata 870kg/m³×22% 147 kg/m³ Density of wet Pinus Radiata 450 kg/m³ plus 1,120 kg/m³ 670 kg/m³

Density of processed Pinus Radiata 597 kg/m³ after kiln drying to 8% Pinus Radiata density increase 597 from 450 33% kg/m³

Table 2 below represents Janka Hardness and Density for the Vecowood product treated according to the formulation shown in Example 1 and other untreated timber such as Radiata Pine, Scots Pine, Beech (not steamed), Western Red Cedar, Meranti (DRM), Sapele Mahogany, Ponderosa Pine,

Acetylated Pine and Acetylated Beech.

TABLE 2

| Lignocellulosic | Janka Hardness | Density |
|---|---|---|
| material Species | kN/mm² | kg/m³ |
| Vecowood produced as | 8240 | 762 |
| described above | | |
| Radiata Pine | 3850 | 497 |
| Scots Pine | 2900 | 513 |
| Beech (not steamed) | 7100 | 721 |
| Western Red Cedar | 1450 | 384 |
| Meranti (DRM) | 4300 | 497 |
| Sapele Mahogany | 6700 | 657 |
| Ponderosa Pine | 3000 | 481 |
| Acetylated Pine | 3950 | 80 |
| Acetylated Beech | 6950 | 115 |

### Example 3

Table 3 below relates to bending strength for the Vecowood product of the according to the formulation shown in Example 1 and other untreated timber such as Radiata Pine, Scots Pine, Beech (not steamed), Western Red Cedar, Meranti (DRM), Sapele Mahogany, Ponderosa Pine, Acetylated Pine and Acetylated Beech.

TABLE 3

| Lignocellulosic | Bending Strength |
|---|---|
| material Species | kN/mm² |
| Vecowood | 150 |
| Radiata Pine | 80 |
| Scots Pine | 80 |
| Beech (not steamed) | 80 |
| Western Red Cedar | 55 |
| Meranti (DRM) | 90 |
| Sapele Mahogany | 105 |
| Ponderosa Pine | 80 |
| Acetylated Pine | 80 |
| Acetylated Beech | 115 |

Table 4 shown below represents density, hardness, radial shrinkage and tangential shrinkage for the Vecowood product referred to above Pinus Radiata green and Pinus Radiata dry.

TABLE 4

| | Pinus Radiata | Pinus Radiata | |
|---|---|---|---|
| | green | dry | Vecowoo |
| Density (kg/m³) | | 496 | 762 |
| Hardness (kg) | | 3850 | 8240 |
| Radial Shrinkage (%) | 3 | | <1 |
| Tangential Shrinkage (%) | 6 | | <1 |

Whilst specific embodiments of the present invention have been described above, it will be appreciated that departures from the described embodiments may still fall within the scope of the present invention. For example, any suitable type of aqueous organic based formulation may be used. The aqueous organic based formulation may also be cured within the microstructure of the lignocellulosic material product using any suitable means.

1-27. (canceled)

28. A method for providing a hardened lignocellulosic material product, said method comprising:
providing a lignocellulosic material product;
impregnating the lignocellulosic material product with an aqueous organic-based formulation;
providing a pressurized environment for the lignocellulosic material product impregnated with the aqueous organic based formulation;
heating the lignocellulosic material product with the impregnated organic based formulation to thereby cure organic material within the lignocellulosic material product;
wherein the cured organic material within the lignocellulosic material product increases the strength of the lignocellulosic material product and provides a hardened lignocellulosic material product.

29. The method of claim 28, wherein the aqueous organic based formulation reacts with the lignocellulosic material to produce a biopolymer within said lignocellulosic material, and the lignocellulosic material product is a soft lignocellulosic material.

30. The method of claim 28, wherein the hardened lignocellulosic material product has one or more physical properties relative to the untreated material selected from the group consisting of increased density; increased hardness; increased strength; increased stiffness; increased fire resistant properties; and improved performance when machined and/or coated with surface coating materials.

31. The method of claim 28, wherein the lignocellulosic material product is selected from the group consisting of Pines; Hemlocks; Aspen; Beach; Birch; Albizzia; Balsa; Iroko (chlorophora excelsa); Jelutong (dyera costulata); Merbau (intsia palembacia); Tawa (beilschmiedia tawa); Radiata Pine (pinus radiate); European Beech (gagus syivatica); Eucalyptus (eucalyptus deglupta); Cotton Wood (populusdeltoids); Rubber Wood (hevea brasiliensis); Baltic Pine (pinus sylvestris); Ponderosa Pine (pinus ponderosa); Hoop Pine (araucaria cunninghamii); Carribbean Pine (pinus caribaea); Loblolly Pine (pinus taeda); Hemlock (tsuga canadensis); Western Juniper (juniperus occidentalis); Poplar (liriodendron tulipifera); Willow (salix nigra); Slash Pine (pinus elliottii); White Pine (pinus strobes); Poplar Hybrid (populus dehoides Xnigra) and Corsican Pine (pinus nigra subsp laricio).

32. The method of claim 28, wherein about 1 m³ of the initial lignocellulosic material is capable of absorbing the aqueous organic-based formulation in an amount greater than about any of the following: 100 litres; 200 litres; 300 litres; 400 litres; 500 litres; 600 litres; 700 litres; 800 litres; 900 litres or 1,000 litres, and wherein the organic based formulation is absorbed and/or impregnated into and/or onto the microstructure of the lignocellulosic material containing the cells, cell walls and/or pores.

33. The method of claim 28, wherein the pressurized environment is a pressure vessel, and wherein in a first step, the pressure inside the pressurized environment vessel is reduced below atmospheric pressure, and wherein by reducing the pressure has the effect that cells and/or pores in the microstructure within the lignocellulosic material product are evacuated of air.

34. The method of claim 28, wherein the aqueous organic based formulation is introduced into the reduced pressure environment as quickly as possible until the reduced pressure environment is flooded with aqueous organic based formulation, wherein once the aqueous organic based solution is in the pressurized environment and has been absorbed and/or impregnated into the lignocellulosic material structure, the pressure in the pressure vessel is increased to above atmospheric pressure and is kept at this increased pressure for about 21 minutes, and wherein the pressure is allowed to return to normal atmospheric pressure after being at above atmospheric pressure.

35. The method of claim 28, wherein the lignocellulosic material product with the impregnated and/or absorbed aqueous organic based formulation is then subjected to a heat treatment which cures the aqueous organic based formulation within the lignocellulosic material product.

36. The method of claim 28, wherein the organic aqueous formulation has a solids content of about 10% by weight (67 kg/m³), about 20% by weight (134 kg/m³), about 30% by weight (201 kg/m³), about 40% by weight (268 g/m³), about 50% by weight (335 kg/m³) or about 60% by weight (402 kg/m³), and wherein the aqueous organic based formulation is a solution comprising an organic material of high molecular weight polymer or resin with a molecular weight of between any of the following: 100-10,000; 150-5,000; 200-1,000; 250-750; 250-500; or 290-470.

37. The method of claim 28, wherein the aqueous organic based formulation comprises an organic material with a high molecular weight polymeric based material including that of a condensation polymer or an amide, an amine, an ester, aldehyde, ketone, anhydride or an alkyd based material, and wherein the organic material in the aqueous organic based formulation is a high-solids, short oil alkyds with a viscosity measure of Z5 to Z6 on the Gardner-Holdt Viscometer Scale at 30° C.

38. The method of claim 28, wherein the hardened lignocellulosic material product formed has a Janka hardness of: at least about 5,000 N/mm²; at least about 6,000 N/mm²; at least about 7,000 N/mm²; at least about 8,000 N/mm²; at least about 8,000 N/mm²; at least about 9,000 N/mm² or at least about 10,000 N/mm², and wherein the hardened lignocellulosic material product formed has a Janka hardness of: about 4,000 N/mm²-20,000 N/mm²; about 4,000 N/mm²-15,000 N/mm²; about 4,000 N/mm²-12,000 N/mm² or about 7,000 N/mm²-10,000 N/mm².

39. The method of claim 28, wherein the hardness of the initial lignocellulosic material product is increased by at least about 10%, at least about 30%, at least about 50%, at least about 70%, at least about 100% or at least about 200%; and the density of initial lignocellulosic material product is increased by at least about 10%, at least about 30%, at least about 50%, at least about 70%, at least about 100% or at least about 200%.

40. The method of claim 28, wherein the hardened lignocellulosic material product formed has a density of: at least about 500 kg/m³; at least about 600 kg/m³; at least about 700 kg/m³; at least about 800 kg/m³; at least about 900 kg/m³ or at least about 1,000 kg/m³; about 400-2,000 kg/m³; about 400-1,500 kg/m³; about 500-1,000 kg/m³; about 600-2,000 kg/m³; or about 700-2,000 kg/m³.

41. A hardened lignocellulosic material product formed according to the process of claim 28.

42. An item of manufacture selected from the group consisting of soffets, window frames, window sills, doors, door frames, conservatories, barge boards, fascia boards, garden sheds, decking, timber framed buildings, furniture, joinery products and food items, comprising the hardened lignocellulosic material product formed according to the process of claim 28.
